(19) United States
(12) Patent Application Publication
(10) Pub. No.: US 2017/0086634 A1
(43) Pub. Date: Mar. 30, 2017

(54) ELECTRICAL GENERATOR SYSTEM FOR USE WITH VEHICLE MOUNTED ELECTRIC FLOOR CLEANING SYSTEM

(71) Applicants: Eric Jacobson, Sedro Woolley, WA (US); Lance Ronal Joseph Koty, Marysville, WA (US)

(72) Inventors: Eric Jacobson, Sedro Woolley, WA (US); Lance Ronal Joseph Koty, Marysville, WA (US)

(21) Appl. No.: 14/871,323

(22) Filed: Sep. 30, 2015

(51) Int. Cl. A47L 11/40; A47L 11/34; H02P 9/04; H02K 7/18; H02K 9/19

(52) U.S. Cl. CPC A47L 11/4011; H02K 7/1815; H02K 9/19; H02P 9/04; A47L 11/34; A47L 11/4091; A47L 11/4083

(57) ABSTRACT

An electrical generator system for a vehicle comprises a power plant having a fluid cooling system, an alternating current generator mechanically coupled to the power plant, a generator control coupled to receive electrical input from the alternating current generator, and an engine speed control configured to receive a control signal from the generator control and to provide an input to the power plant to control speed of the power plant. The fluid cooling system can be configured to cool the alternating current generator. In one example, the generator can be used to electrically power a motor that can be used to mechanically power a liquid pump and an air blower. In one example, the fluid cooling system can be used to cool the generator and the motor, and heat liquid pumped by the liquid pump. In one example, the heated liquid can be used in conjunction with a carpet cleaning tool that utilizes a vacuum generated by the air blower.

### TECHNICAL FIELD

The present disclosure pertains generally, but not by way of limitation, to power generating equipment. By way of example only, the power generating equipment of the present disclosure may be used in portable cleaning systems that can be used to clean various surfaces, such as floors.

### BACKGROUND

Cleaning carpet, upholstery, tile floors, and other surfaces enhances the appearance and extends the life of such surfaces by removing the soil embedded in the surface. Moreover, carpet cleaning removes allergens, such as mold, mildew, pollen, pet dander, dust mites, and bacteria. Indeed, regular cleaning keeps allergen levels low and thus contributes to an effective allergy avoidance program.

Vacuum extractors for cleaning surfaces, such as carpet, typically deposit a cleaning fluid, such as water with or without a chemical additive, upon the carpet or other surface to be cleaned. The combination of deposited fluid and the soil entrained in the fluid (e.g. “gray water”) are subsequently removed by high vacuum suction. This enables carpet to be completely dry before mold has time to grow. The gray water is then separated from the working air of the vacuum suction and is collected in a vacuum recovery tank.

Due to the prevalence of carpeted surfaces in commercial establishments, institutions, and residences, there exists a thriving commercial carpet cleaning industry. In order to maximize the efficacy of the cleaning process, industrial floor cleaning systems should be powerful to minimize the time in which the soil entrained cleaning fluid is present in the carpet. Industrial floor cleaning systems should also be durable. That is, such a cleaning system should be manufactured from durable working parts so that the system has a long working life and requires little maintenance.

Industrial floor cleaning systems generally provide for the management of heat, vacuum, pressure, fresh and gray water, chemicals, and power to achieve the goal of efficient, thorough cleaning of different surfaces, usually carpets but also hard flooring, linoleum and other surfaces, in both residential and commercial establishments. Professional surface cleaning systems are also utilized in the restoration industry for water extraction.

Of the many industrial surface cleaning systems available, a major segment are self-contained and have a heat source, vacuum source, chemical delivery system, and water dispersion and extraction capabilities. These are commonly referred to as “truck-mounted” systems and install permanently in cargo vans, trailers, and other commercial vehicles. Truck-mounted systems comprise a series of components designed and integrated into a package with an overall goal of performance, economy, reliability, safety, useful life, serviceability, and sized to fit in various commercial vehicles.

Current truck-mounted carpet cleaning machines use the internal combustion engine from the truck to drive the mechanical components (i.e., vacuum pumps, high pressure water pumps) of the system. Airflow and pressure within the system are typically controlled mechanically. Water temperature is typically controlled with valves, solenoids, and electric switches.

As a result, control of airflow, pressure and temperature with mechanical drive systems is limited by the design of the vehicle and the internal combustion engine used in the vehicle. This results in a limited number vehicles that can be used for the installation of the cleaning equipment. Mechanical drive systems must have a direct connection between the drive source (e.g. internal combustion engine) and the driven component (e.g. vacuum pump, water pump). This direct “line of sight” requirement results in modifications being required to the host vehicle, such as drilling and cutting holes in significant portions of the vehicle structure. Some vehicles cannot be utilized due to the physical design and layout of the vehicle power train. Since the drive system is fixed, the speed ratio between the engine and the driven components is also fixed by the system design.

In an attempt to simplify the installation of the cleaning system without having to make significant modifications to the vehicle, “slide-in” systems have been developed. Slide-in systems generally involve mounting of all the components of the vacuum system to a platform that can be placed, or slid, into the cargo area of a vehicle, such as a van. In other examples, these systems can alternatively be mounted on portable, wheeled carts. These systems have a dedicated power plant, such as an internal combustion engine, separate from the vehicle power plant. As such, these systems can be considerably more heavy and bulkier than truck-mounted systems. Furthermore, these systems also require ventilation systems to evacuate exhaust from the power plant from within the cargo area.

Performance of truck-mounted and slide-in cleaning systems relies on the operating conditions of the power plant to operate the cleaning system. For example, some cleaning surfaces require lower amounts of vacuum pressure and airflow so as not to damage the surface (i.e., upholstery). Common methods for controlling vacuum pressure are manually adjusted relief valves at the tool, hose, or on the machine. Methods for controlling air flow include changing the speed of the internal combustion engine. Changing the speed of the internal combustion engine changes where the engine operates in its efficiency curve. Lowering the speed generally means the engine is running less efficiently.

Also, different types of soil respond to different temperatures. Most cleaning equipment can only provide temperature control at the machine with little or no control over the applied temperature to the cleaning surface. Current truck-mounted carpet cleaning machines heat water by various heat transfer methods, either water-to-water or air-to-water. Available heat sources include the following: 1) the coolant system of the internal combustion engine, 2) vacuum pump exhaust, and 3) fuel fired heating equipment. Methods for controlling the temperature include mechanical thermostats, ball valves, water mixing valves, mechanical and electric float switches, mechanical and electric pressure switches, and mechanically operated air flow valves all designed to divert the path or flow of either the heating medium or the heated medium. These control systems typically have a large hysteresis, which can result in uneven application of heated cleaning solutions, affecting the appearance of cleaning results. Additionally, mechanical temperature control systems can provide imprecise control, which can result in temperature variation in the cleaning solution.

Furthermore, loss of heat through the solution hose can result in temperature variations at the cleaning surface. Changing the length of the hose can result in a change in temperature at the cleaning surface, without any measured change elsewhere in the system. These limitations can require the operator to estimate line loss and cleaning performance based on experience.

Overall system controls are generally limited to on/off switches, mechanical temperature controls, and mechanical and electric limit switches for pressure and volume. These controls require intervention by the operator to manually set limits and controls. Mechanical vacuum relief valves on the system result in waste of power (loss of system efficiency) as power is consumed to move air through the relief valve but provides no value to the cleaning process.

Example truck-mounted cleaning systems are described in U.S. Pat. No. 4,158,248 to Palmer and U.S. Pat. No. 6,675,437 to York. Example slide-in cleaning system are described in U.S. Pat. No. 7,208,050 to Boone et al. and U.S. Pat. No. 7,681,280 to Hayes et al.

### Overview

To better illustrate the electrical power generator and cleaning systems disclosed herein, a non-limiting list of examples is provided here:

In Example 1 a cleaning system can include: a power plant having a fluid cooling system; a generator mechanically coupled to the power plant; a motor electrically coupled to the generator; a pump coupled to the motor and configured for generating pressurized liquid; a blower coupled to the motor and configured for generating pressurized air; and a cleaning tool fluidly coupled to a pump outlet and a blower inlet; wherein the fluid cooling system is configured to heat liquid for the cleaning tool and cool the generator and motor.

In Example 2, the cleaning system of Example 1 is optionally configured to include first cooling lines connecting the fluid cooling system of the power plant and the generator to circulate coolant therebetween.

In Example 3, the cleaning system of any one of or any combination of Examples 1 and 2 is optionally configured to include second cooling lines connecting the fluid cooling system of the power plant and the motor in order to circulate fluid therebetween; and a liquid-to-liquid heat exchanger in fluid communication with the second cooling lines and an inlet configured to receive liquid from the pump and an outlet for providing heated liquid to the cleaning tool.

In Example 4, the cleaning system of any one of or any combination of Examples 1-3 is optionally configured to include a preheater liquid-to-liquid heat exchanger configured to heat liquid stored in a container using heated coolant from the fluid cooling system.

In Example 5, the cleaning system of any one of or any combination of Examples 1-4 is optionally configured to include a resistance heater positioned to heat liquid between the liquid-to-liquid heat exchanger and the cleaning tool.

In Example 6, the cleaning system of any one of or any combination of Examples 1-5 is optionally configured to include a resistance heater disposed in a hose connecting the cleaning tool to the liquid-to-liquid heat exchanger.

In Example 7, the cleaning system of any one of or any combination of Examples 1-6 is optionally configured to include a liquid-to-air heat exchanger positioned between the resistance heater and the liquid-to-liquid heat exchanger and configured to exchange heat between discharge air of the blower and the heated liquid.

In Example 8, the cleaning system of any one of or any combination of Examples 1-7 is optionally configured to include a temperature sensor positioned between the resistance heater and the cleaning tool; and a bypass valve connected to allow liquid to bypass the liquid-to-air heat exchanger when the temperature sensor senses a threshold temperature.

In Example 9, the cleaning system of any one of or any combination of Examples 1-8 is optionally configured to include a generator control connected to the generator to convert alternating current to direct current; and a motor control connected to the generator control and the motor to convert direct current to alternating current.

In Example 10, the cleaning system of any one of or any combination of Examples 1-9 is optionally configured to include a pressure control connected to the motor control and configured to adjust a voltage signal sent to the motor by the motor controller to limit a maximum air pressure at the wand; and a flow control connected to the motor control and configured to adjust a voltage signal sent to the motor by the motor control to limit a minimum airflow through the wand.

In Example 11, the cleaning system of any one of or any combination of Examples 1-10 is optionally configured to include a vacuum sensor connected to the motor control and configured to sense a pressure of a vacuum tank connected to the blower.

In Example 12, a method of operating a cleaning system can include: driving an electric generator with a power plant of a vehicle; powering an electric motor with power from the electric generator; cooling the electric generator and the electric motor with cooling fluid of the power plant; heating a cleaning fluid with heat from the cooling fluid; and driving a fluid pump with the electric motor to pump cleaning fluid to a cleaning tool.

In Example 13, the method of Example 12 is optionally configured to include heating the cleaning fluid with heat from the cooling fluid at the fluid pump inlet and the fluid pump outlet using liquid-to-liquid heat exchangers.

In Example 14, the method of any one of or any combination of Examples 12 and 13 is optionally configured to include heating the cleaning fluid between the cooling fluid and the cleaning tool with an electric heater.

In Example 15, the method of any one of or any combination of Examples 12-14 is optionally configured to include driving a blower with the electric motor to draw cleaning fluid away from a discharge of the cleaning tool.

In Example 16, the method of any one of or any combination of Examples 12-15 is optionally configured to include heating the cleaning fluid in route to the cleaning tool with discharge air from the blower using a liquid-to-air heat exchanger.

In Example 17, the method of any one of or any combination of Examples 12-16 is optionally configured to include sensing a temperature of the cleaning fluid at the cleaning tool; and bypassing the liquid-to-air heat exchanger when a sensed temperature exceeds a threshold temperature.

In Example 18, the method of any one of or any combination of Examples 12-17 is optionally configured to include controlling output of the electric generator with a generator control that converts alternating current to direct current; and controlling input to the electric motor with a motor control that converts direct current to alternating current.

In Example 19, the method of any one of or any combination of Examples 12-14 is optionally configured to include adjusting a voltage signal sent to the electric motor by the motor control to limit a maximum air pressure at the cleaning tool; and adjusting a voltage signal sent to the electric motor by the motor control to limit a minimum airflow through the cleaning tool.

In Example 20, the method of any one of or any combination of Examples 12-19 is optionally configured to include sensing pressure in a vacuum tank connected to the blower.

In Example 21, an electrical generator system for a vehicle can include: a power plant having a fluid cooling system; an alternating current generator mechanically coupled to the power plant; a generator control coupled to receive electrical input from the alternating current generator; and an engine speed control configured to receive a control signal from the generator control and to provide an input to the power plant to control speed of the power plant; wherein the fluid cooling system is configured to cool the alternating current generator.

In Example 22, the electrical generator system of Example 21 is optionally configured to include a power plant comprising an internal combustion engine that generates rotational shaft power; and a fluid cooling system including a heat exchanger configured to exchange heat from coolant heated by the power plant to the atmosphere.

In Example 23, the electrical generator system of any one of or any combination of Examples 21 and 22 are optionally configured to include a plurality of electrical contactors configured to interrupt reception of electrical input from the alternating current generator by the generator control; and a battery connected to the generator control.

In Example 24, the electrical generator system of any one of or any combination of Examples 21-23 is optionally configured to include an inverter connected to the generator control to generate direct current power.

In Example 25, the electrical generator system of any one of or any combination of Examples 21-24 is optionally configured to include a motor electrically powered by the alternating current generator.

In Example 26, the electrical generator system of any one of or any combination of Examples 21-25 is optionally configured to include a liquid pump mechanically powered by the motor; and an air blower mechanically powered by the motor.

In Example 27, the electrical generator system of any one of or any combination of Examples 21-26 is optionally configured to include a fluid cooling system used to cool the generator and the motor, and heat liquid pumped by the liquid pump.

In Example 28, the electrical generator system of any one of or any combination of Examples 21-27 is optionally configured to include heated liquid used in conjunction with a carpet cleaning tool that utilizes a vacuum generated by the air blower.

Each of these non-limiting examples can stand on its own, or can be combined in any permutation or combination with any one or more of the other examples. This overview is intended to provide an overview of subject matter of the present patent application. It is not intended to provide an exclusive or exhaustive explanation of the present subject matter. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagrammatic illustration of an industrial slide-in cleaning system installed in a truck.

FIG. 2 is a schematic illustration of an electric carpet cleaning system showing fluid and mechanical connections, in accordance with at least one example of the present disclosure.

FIG. 3 is a schematic illustration of an electrical system for the electric carpet cleaning system of FIG. 2, in accordance with at least one example of the present disclosure.

FIG. 4 is a schematic illustration of a temperature control circuit for the electric cleaning system of FIG. 2, in accordance with at least one example of the present disclosure.

FIG. 5 is a schematic illustration of the electrical system of FIG. 3 configured to have an A/C voltage output, in accordance with at least one example of the present disclosure.

### DETAILED DESCRIPTION

The present application is directed to a vehicle-mounted cleaning system that can utilize the power plant of the vehicle to mechanically drive an electric generator. The electric generator can subsequently provide electrical power to an electric motor that can be used to mechanically drive a vacuum pump and a liquid pump. As such, the power plant of the vehicle can be left to operate at an efficient level while the cleaning system is used, but the electric generator is capable of operating within the entire operating range of the power plant.

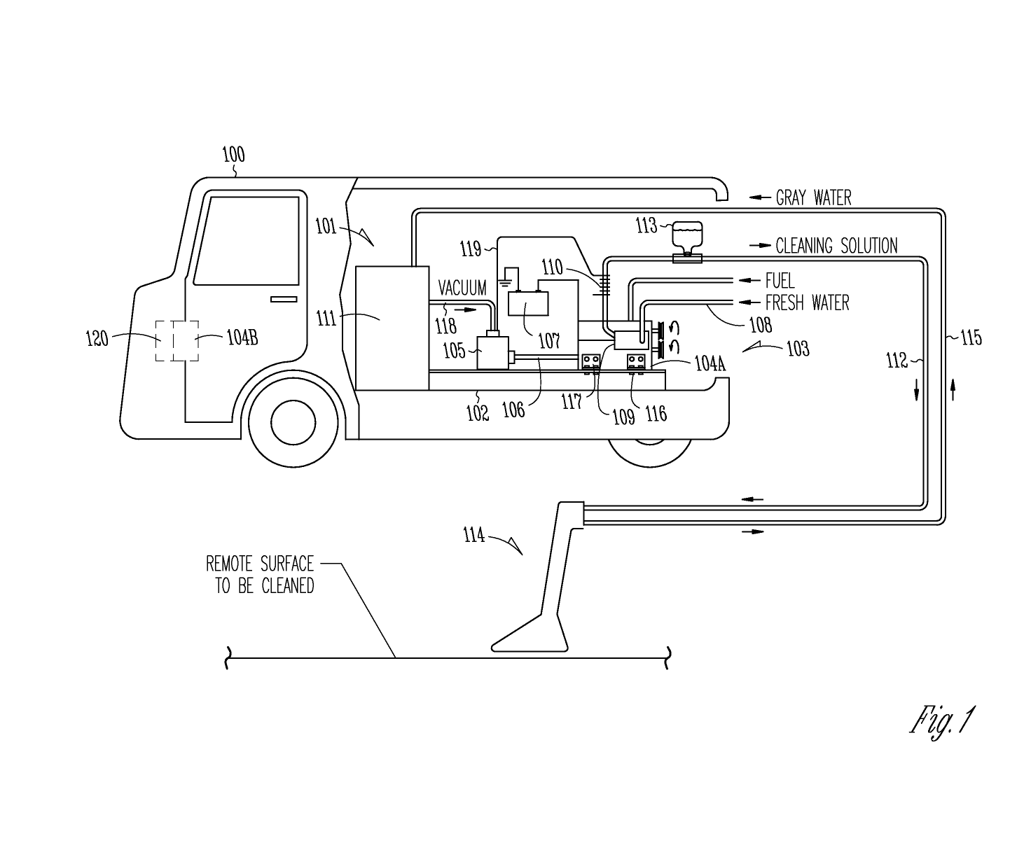

FIG. 1 is a diagrammatic illustration of truck 100 having slide-in cleaning system 101 configured for cleaning carpets, hard flooring, linoleum, and other surfaces. As illustrated in FIG. 1, cleaning system 101 can include structural platform or support frame 102 onto which various components can be mounted. In an example, cleaning system 101 can include drive system 103 mounted on support frame 102 and having power plant 104A coupled to receive fuel from an appropriate supply, air pump 105 that can operate as the vacuum source for removing soiled liquid (“gray water”) from the cleaned surface, and interface assembly 106 for transmitting power from power plant 104A to air pump 105. Power plant 104A can be, for example, any steam or internal combustion motor, such as a gasoline, diesel, alcohol, propane, or other fueled internal combustion engine. With further reference to FIG. 1, battery 107 can be provided as a source of electric energy for starting power plant 104A. Intake hose 108 can be coupled to a source of fresh water, and water pump 109 can be driven by power plant 104A via any suitable means, such as a V-belt or a direct drive, for pressurizing the fresh water.

As discussed above, in a vehicle-mounted system, blower 105 and pump 109 can be driven by the engine of the vehicle in which the cleaning system is mounted, such as power plant 104B of truck 100, rather than a separate, dedicated engine, such as power plant 104A.

One or more heat exchanger systems 110 can be coupled for receiving and heating the pressurized fresh water. Recovery tank 111, also referred to as a vacuum tank, can be provided for storing gray water after removal from the cleaned surface. High pressure solution hose 112 can be provided for delivering pressurized, hot water or a hot water and chemical solution from cleaning system 101 to a surface to be cleaned. In an example, chemical container 113 or other chemical system can be coupled for delivering a stream of cleaning chemical into the hot water as it enters high-pressure solution hose 112. At least one wand 114 can be coupled to high pressure solution hose 112 for receiving and dispersing the pressurized hot water or hot water and chemical cleaning solution to the surface to be cleaned. In various examples, two or more wands 114 can be provided, wherein each wand 114 is coupled to a dedicated high pressure solution hose 112. Wand 114 can be removed from the vehicle and carried to the carpet or other surface to be cleaned. Thus, in an example, wand 114 can be the only part of cleaning system 101 that is portable by an operator of system 101 during use, with all other components of cleaning system 101 remaining stationary within the vehicle during a cleaning operation. Wand 114 can be coupled via vacuum hose 115 to recovery tank 111, which can in turn be coupled to the high vacuum provided by air pump 105, for recovering the used cleaning solution from the cleaned surface and delivering it to recovery tank 111.

In an example, power plant 104A and air pump 105 of drive system 103 can be independently hard-mounted on support frame 102 either directly using one or more mechanical fasteners 116, or indirectly using one or more mounting plates or brackets 117. Water pump 109 can be mounted directly to power plant 104A, as shown, but can alternatively be mounted to support frame 102. Any suitable mechanical fasteners 116 can be used including, but not limited to, bolts, screws, or the like. Brackets 117 can be formed from any suitable material, such as metal. Support frame 102 can be configured for mounting in a van, truck or other suitable vehicle for portability, as illustrated in FIG. 1. In an example, Support frame 102 can be wheeled for portability independent of the vehicle, and can optionally be sized and structured to incorporate recovery tank 111.

Various types of interface assemblies 106 can be used for transmitting power from power plant 104A to air pump 105. One type of interface assembly that can be used for transmitting power from power plant 104A to air pump 105 is a rigid, direct drive coupling. Another type of interface assembly can include a belt drive system, which can be configured to transmit power through a series of pulleys and belts coupled to power plant 104A and air pump 105. In various examples, any other known interface assembly suitable for transferring rotational shaft power can be used.

Air pump 105 can be coupled via vacuum piping 118 for generating high vacuum in recovery tank 111, which can provide a suitable volume for carpet and other surface cleaning operations and can include baffles, filters, and/or other means for preventing gray or other water from entering air pump 105. Additionally, air pump 105 itself can be designed to be substantially impervious to water and debris ingestion. Recovery tank 111 can be mounted, for example, in the vehicle near drive system 103. An output of air pump 105 can be operably coupled, via exhaust piping 119, to heat exchanger system 110 for delivering exhaust gases to heat the pressurized water.

Cleaning system 101 can operate by delivering fresh water to an inlet of intake hose 108 utilizing, for example, a standard garden hose or a fresh-water container. The system can add energy to the fresh water, i.e., pressurize it, by means of pump 109. The fresh water can be pushed throughout the one or more heat exchanger systems 110 using pressure provided by pump 109. The one or more heat exchanger systems 110 can gain their heat by thermal energy rejected from air pump 105 or power plant 104A, e.g., from hot exhaust gasses, coolant water used on certain engines, or other suitable means. On demand from wand 114, pump 109 can drive the heated water through solution hose 112 where one or more cleaning chemicals can be added from chemical container 113, and then can deliver the water-based chemical cleaning solution to wand 114 for cleaning the floor, carpet or other surface. In one example, the hot water can travel, for example, between about fifty feet and about three-hundred feet to wand 114. The operator can deliver the hot solution via wand 114 to the surface to be cleaned, and can almost immediately extract the solution along with soil that has been emulsified by thermal energy or dissolved and divided by chemical energy. The extracted, soiled water can be drawn via vacuum hose 115 into recovery tank 111 for eventual disposal as gray water. An auxiliary pump (not shown), commonly referred to as an APO or Automatic Pump Out device, may be driven by power plant 104A for automatically pumping the gray water from recovery tank 111 into a sanitary sewer or other approved dumping location. Alternatively, this task can be performed manually.

The present disclosure is directed to an electric cleaning system that utilizes a power plant, such as power plant 104A or 104B, to mechanically drive an electrical generator, which can subsequently be used to provide electrical power to an electric motor that drives liquid pump 109 and air pump 105 or other air pumps, water pumps or blowers. Cooling fluid, such as a refrigerant circulated between power plant 104B and radiator 120, can be used to cool the electrical generator and electric motor.

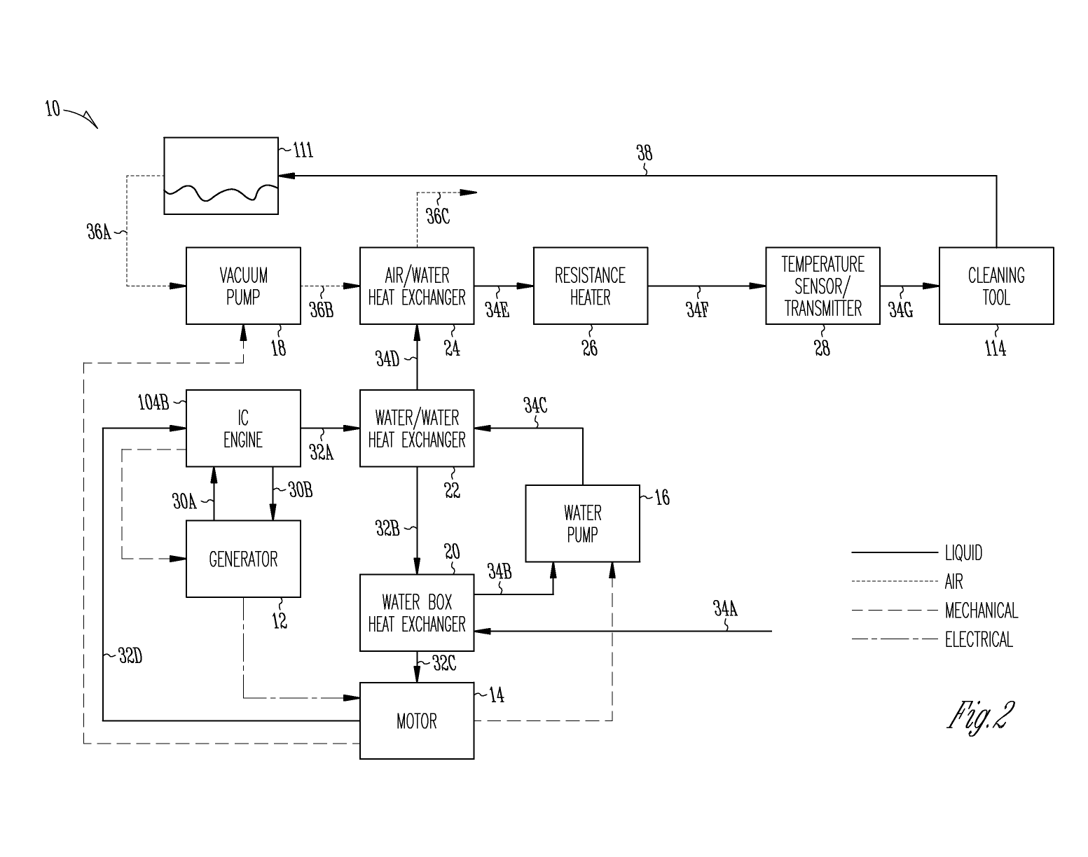

FIG. 2 is a schematic illustration of an electric carpet cleaning system 10 showing fluid and mechanical connections, in accordance with at least one example of the present disclosure. System 10 can be incorporated into a vehicle, such as van 100, as an alternative to a slide-in or truck-mounted cleaning system. Electric carpet cleaning system 10 can include generator 12, electric motor 14, water pump 16 and vacuum pump 18. System 10 can also include first heat exchanger 20, second heat exchanger 22 and third heat exchanger 24. System 10 can also include electric heater 26 and temperature sensor 28.

System 10 can operate under power from a prime mover, such as a vehicle engine similar to power plant 104B. System 10 can operate to provide heated water to and suction from a cleaning instrument, such as wand 114. System 10 can, however, be used with other power plants and cleaning instruments.

Generator 12 can be coupled directly to power plant 104B such that mechanical output of power plant 104B is input into generator 12. In one example, rotational output of power plant 104B can be transferred to an input shaft of generator 12 via various means, such as belts, shafts and the like, as described above with reference to interface assemblies 106. Generator 12 can convert rotational input to electrical power, such as via a magneto-electric converter. Electricity produced by generator 12 can be transmitter to motor 14. Motor 14 can provide mechanical input to water pump 16 and vacuum pump 18. Water pump 16 can comprise any suitable pump as is conventionally known, such as positive displacement liquid pumps including reciprocating piston pumps, rotary pumps, gear pumps, screw pumps and the like. Vacuum pump 18 can comprise any suitable pump as is conventionally known, such as positive displacement air pumps, impellers, fans, blowers and the like.

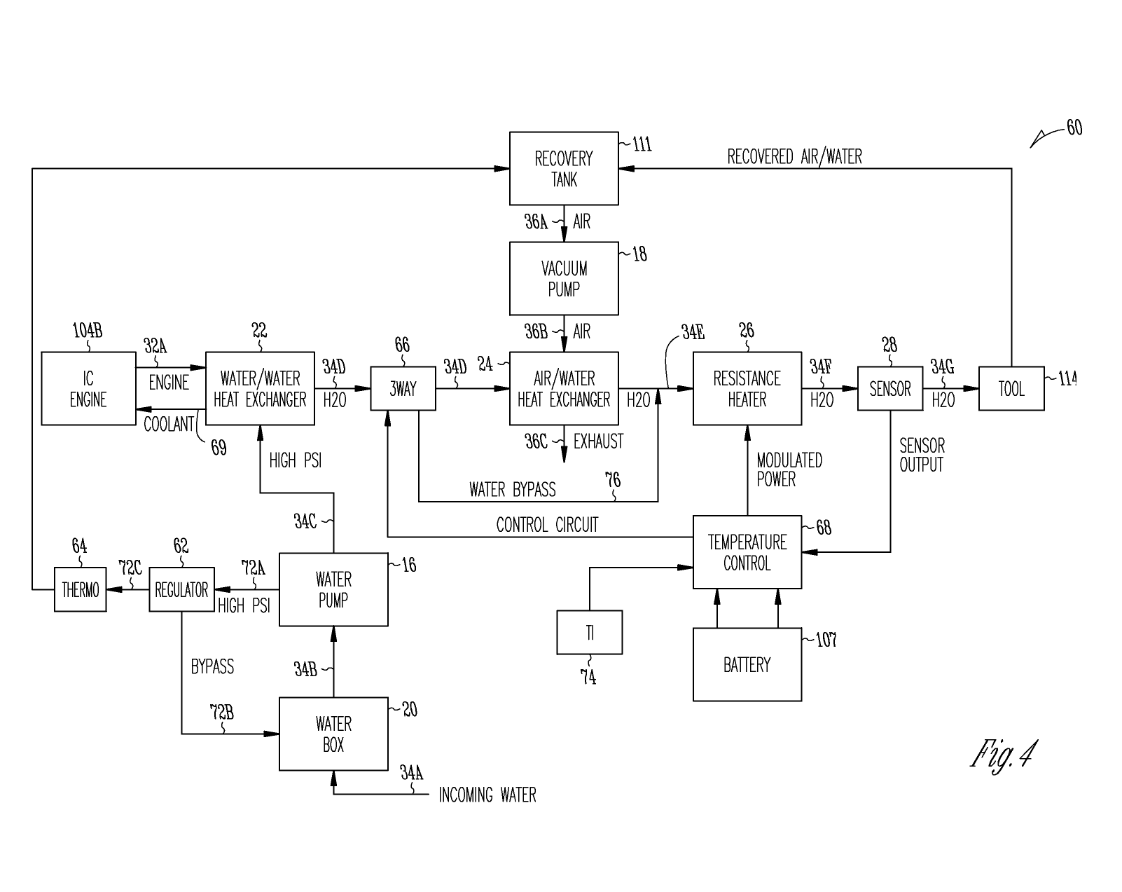

Power plant 104B can include a cooling system in which a cooling fluid, such as a coolant or refrigerant or water, is circulated to dump heat generated from the combustion in power plant 104B to the surrounding atmosphere using, for example, radiator 120 (FIG. 1). Cooling for generator 12 and motor 14 can be accomplished by running auxiliary engine coolant loops from power plant 104A through both generator 12 and motor 14 after being cooling in radiator 120, for example. Power plant cooling fluid diverted from power plant 104A can also be run through second heat exchanger 22 to first lower the temperature of the cooling fluid before being used to cool generator 12 and motor 14. If additional cooling is desired, the cooling fluid can also be directed through either a secondary liquid-to-liquid heat exchanger or an additional air-to-liquid heat exchanger in order to further reduce the temperature of the cooling fluid before it reaches motor 14 and generator 12. Temperature sensors inside both generator 12 and motor 14 can be used in conjunction with a system control, e.g. temperature control 74 (FIG. 4), to control the flow of cooling fluid through the auxiliary engine coolant loops. Generator 12 can be connected into the cooling system using a first set of cooling lines 30A and 30B. For example, cooling line 30A can provide a cooled liquid to generator 12 and cooling line 30B can return the heated liquid to the cooling system for cooling, such as via radiator 120 that is air cooled.

First and second heat exchangers 20 and 22 can comprise liquid-to-liquid heat exchangers. Third heat exchanger 24 can comprise a liquid-to-air heat exchanger. In various examples, any suitable heat exchanger can be used, such as plate/fin heat exchangers or micro-channel heat exchangers.

Cooling fluid from the cooling system of power plant 104B can also be circulated through a second system of cooling lines 32A-32D. Cooling fluid heated in power plant 104B can be provided to second heat exchanger 22 via line 32A, then to first heat exchanger 20 via line 32B. As such, as explained below, heat from power plant 104B can be input into liquid used to clean in conjunction with wand 114. As such, the cooling fluid is lowered in temperature and can be used to cool motor 14 via line 32C. After cooling motor 14 the fluid can be returned to the cooling system of power plant 104B via line 32D.

Low pressure water, which can typically be cold water, is provided to first heat exchanger 20 via water line 34A. First heat exchanger 30 can be used in conjunction with a water storage container, or water box, that is used to bring clean water into system 10. As discussed below with reference to FIG. 4, a stand-alone water box can be used without a heat exchanger. Thus, within first heat exchanger 20, cold water can be imparted with heat from cooling fluid of the cooling system of power plant 104B. From first heat exchanger 20 the warmed water flows into water pump 16 via water line 34B. For example, water can be drawn into water pump 16 via pressure generated by pump 16. High pressure warmed water generated by water pump 16 can be provided to second heat exchanger 22 via water line 34C. Within second heat exchanger 22, high pressure warmed water can be further heated by cooling fluid directly leaving power plant 104B. As such, hot water can be provided to third heat exchanger 24 via water line 34D.

Under pressure from water pump 16, the hot water can flow from third heat exchanger 24 to resistance heater 26 via water line 34E, then to temperature sensor 28 via line 34F and then to wand 114 via line 34G.

Hot water provided to third heat exchanger 24 can be further heated by hot exhaust air from vacuum pump 18. Vacuum pump 18 can draw in cool air from air line 36A, which may or may not be configured to draw air from recovery tank 111, and pressurizes the air, thereby heating the air. In one example, air line 36A is connected to recovery tank 111 to provide the suction to wand 114. The heated air can be provided to third heat exchanger 24 via air line 36B. Thus, heat from the air can be imparted to hot water within third heat exchanger 24. The cooled air can be dumped to the atmosphere via air line 36C.

Resistance heater 26, or another electrically activated heater, can be further used to heat the water just before wand 114. Resistance heater 26 can be selectively operated, as discussed below with reference to FIG. 4, in order to provide precise temperature control at the surface to be cleaned, thereby eliminating or reducing wide temperature variations that may arise due to mechanical temperature control means.

Hot water can thereby be provided to wand 114 to perform cleaning of a surface, such as carpet. Dirty, gray water is drawn from the cleaning surface via suction line 38, which, using the vacuum generated by vacuum pump 18, pulls the water into recovery tank 111. The dirty water can be trapped and stored within recovery tank 111, while cold air is drawn from recovery tank 111 into vacuum pump 18.

System 10 provides a more overall efficient system for cleaning surfaces. Power plant 104B can be can be operated at one continuous speed, maintaining optimal efficiency level for power plant 104B, rather than as is dictated by the demands of system 10. Electric generator 12 can also be ran at one continuous speed during surface cleaning operation, thereby maintaining optimal electrical efficiency. Electric generator 12 can be capable of operating within the entire revolutions per minute (RPM) range of power plant 104B, thereby eliminating the need to decouple generator 12 from power plant 104B during normal driving conditions.

Furthermore, removal of the mechanical connection between the drive components (e.g. power plant 104B) and the driven components (e.g. water pump 16 and vacuum pump 18) eliminates rotating equipment (e.g. clutches, shafts, bearings, universal joints) that have a limited service life and require maintenance. It also reduces the modification required to the host vehicle structure, such as van 100.

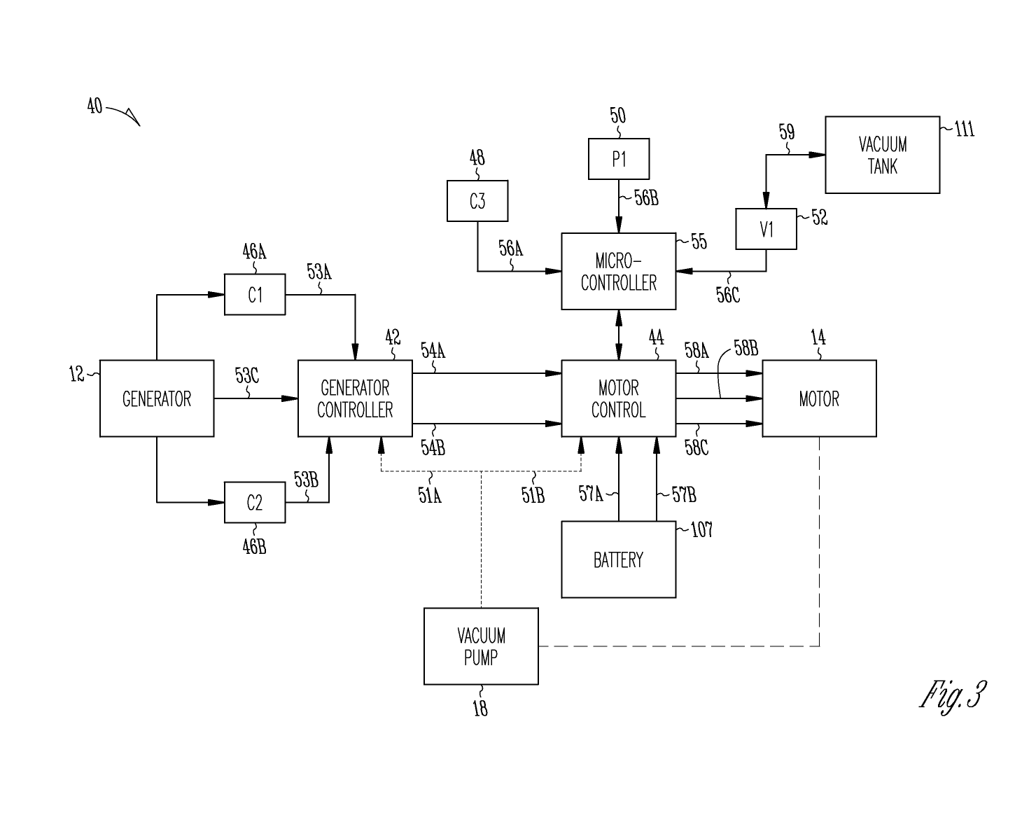

Additionally, system 10 allows for efficient and accurate control of air flow, air pressure and water temperature within system 10 using electric and thermal control systems, such as those discussed with reference to FIGS. 3-5.

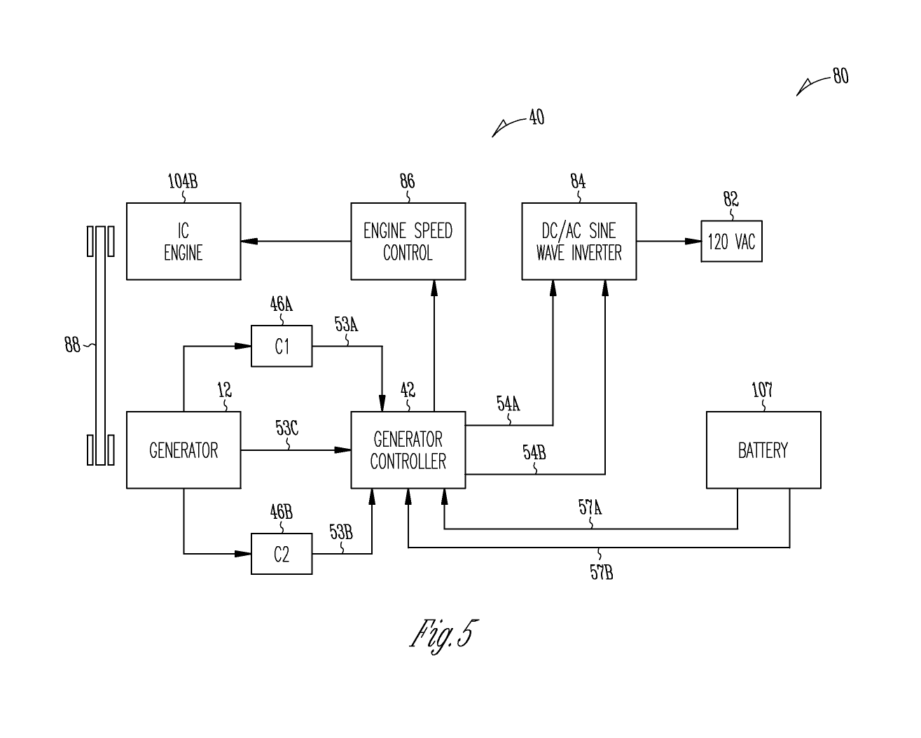

FIG. 3 is a schematic illustration of electrical system 40 for electric carpet cleaning system 10 of FIG. 2. In a base example, electrical system 40 can include generator 12, battery 107, generator control 42, first contactor 46A, and second contactor 46B. Such a base configuration can be used to provide electric power to a variety of systems, such as a carpet and floor cleaning system. In such an example, electrical system 40 can further include components to drive an electric motor, such as motor 14, motor controller 44, flow control 48, pressure control 50 and vacuum sensor 52. In other examples, electrical system 40 can be used to provide electric power to other systems, as is described below with reference to FIG. 5.

Generator 12 can comprise a three-phase, alternating current (AC) generator, as is known in the art. In one example, generator 12 can have a 18 KW rating/capacity. The three different electrical currents produced by generator 12 can be connected to generator control 42 via power lines 53A, 53B and 53C. Contactors 46A and 46B can be connected into power lines 53A and 53B to provide shut-offs to current running therethrough. Contactors 46A and 46B can act as a safety mechanism to cut power to generator control 42 and can thus be connected to motor control 44 to be automatically opened under threshold conditions. In another example, contactors 46A and 46B can be manually opened. Generator control 42 can effectively operate with fixed input from generator 12 or with variable output of generator 12, depending on, for example, the operating conditions of power plant 104B in order to provide continuous output to motor control 44. Generator control 42 can convert the three-phase power of generator 12 into direct current (DC). In one example, generator control 42 comprises an AC-to-DC converter, as is known in the art. As such, positive and negative terminals 54A and 54B can be connected to motor control 44.

Motor control 44 can receive various inputs of system 10 and make adjustments to the operation of motor 14 in response thereto. In one example, motor control 44 is coupled to micro-controller 55 that receives inputs from flow control 48, pressure control 50 and vacuum sensor 52 through control lines 56A, 56B and 56C, respectively. Micro-controller 55 can condition and convert raw signals from flow control 48, pressure control 50 and pressure sensor 52 into signals useable by motor control 44. In one example, motor control 44 and micro-controller comprise any suitable devices as are known in the art. Motor control 44 and micro-controller 55 can be powered by battery 107, such as by connection of positive and negative terminals 57A and 57B to motor control 44. In another example, motor control 44 and micro-controller 55 can be powered by the electrical system of van 100. Motor control 44 can provide three-phase power to motor 14 via power lines 58A, 58B and 58C. In one example, motor 14 can have an 18 kW rating/capacity, and can comprise any suitable motor as is known in the art, such as a magneto-electric motor.

Generator control 42 and motor control 44, as well as micro-controller 55, can be actively cooled by use of air flow created by vacuum pump 18. Air recovered from the cleaning process, such as air in line 36A of FIG. 2, can be directed into air lines 51A and 51B and then past one or more heat sinks (not shown) attached to the controllers to provide a desirable cooling effect for full power operation. In one example, the heat sinks can be integrated into recovery tank 111 such that generator control 42, motor control 44 and micro-controller 55 are mounted on or in close proximity to recovery tank 111.

Flow control 48 can comprise an operator-adjustment that can be located on wand 114. Flow control 48 allows the operator to adjust the volumetric flow rate, e.g. cubic feet per minute, of air through wand 114. Flow control 48 can adjust the voltage provided to motor 14 by motor control 44 via power lines 58A, 58B and 58C to control the speed of motor 14, which thereby adjusts the speed of vacuum pump 18. Flow control 48 can control the minimum amount of airflow through wand 114 by setting the minimum speed of motor 14.

Pressure control 50 can comprise an operator-adjustment that can be located on wand 114. Pressure control 50 allows the operator to adjust the air pressure generated by system 10. For example, system 10 may operate to generate a default suction pressure at wand 114. However, it can be desirable for an operator to use a lower pressure when cleaning delicate materials. Pressure control 48 can adjust the voltage provided to motor 14 by motor control 44 via power lines 58A, 58B and 58C to control the speed of motor 14, which thereby adjusts the speed of vacuum pump 18. Pressure control 48 can control the maximum air pressure at wand 114 by setting the maximum speed of motor 14.

Pressure sensor 52 can be positioned on recovery tank 111 or vacuum line 59 extending therefrom. In another example, pressure sensor 52 can be placed in suction line 38 or air line 36A. Pressure sensor 52 provides a pressure signal to micro-controller 55 that is used in determining the appropriate speed of motor 14 based on inputs from flow control 48 and pressure control 50. Micro-controller 55 can include programming or logic to control motor 14. For example, if pressure control 50 sets the maximum value of pressure in system 10, motor control 44 can take a reading from pressure sensor 52 to determine if the actual pressure needs to be increased or decreased, and subsequently issue a corresponding control signal to motor 14 to increase or decrease motor speed.

With the electric cleaning system described herein, operator controls are provided that allow the operator to choose the appropriate air flow and vacuum pressure for a particular cleaning operation without changing the speed of power plant 104B of truck 100. By driving positive displacement vacuum pump 18 with electric motor 14, the airflow pressure and volume can be controlled by setting the speed of vacuum pump 18, which can be precisely controlled by electronic speed feedback provided by flow control 48 and pressure control 50 that can send signals to motor control 44 to precisely control the speed of vacuum pump 18 in conjunction with input from pressure sensor 52. This eliminates the need for a mechanical vacuum relief valve that wastes energy. Further, the operator can continue to operate want 114 while making system adjustments and the operator does not have to return to van 100 to adjust mechanical system components to make air and temperature adjustments.

FIG. 4 is a schematic illustration of temperature control circuit 60 for electric cleaning system 10 of FIG. 2. Temperature control circuit 60 includes water pump 16, vacuum pump 18, a water box of first heat exchanger 20, second heat exchanger 22, third heat exchanger 24, resistance hater 26 and sensor 28, as discussed above. Temperature control circuit 60 also includes regulator 62, thermo valve 64, 3-way valve 66 and temperature control 68.

In the example of FIG. 4, the water box of heat exchanger 20 is not coupled to coolant from power plant 104B, as is shown in FIG. 2. As such, temperature control circuit 60 provides heating to system water only at heat exchanger 22, heat exchanger 24 and heater 26. As such, power plant 104B can provide hot coolant to second heat exchanger 22 via line 32A. However, rather than continuing through lines 34B-34D as shown in FIG. 2, the coolant can be directly returned to power plant 104B via line 69. However, as discussed above, coolant from power plant 104B can be used to cool other devices of system 10, including electric generator 12 and electric motor 14.

The water box of heat exchanger 20 and water pump 16 can be connected into regulator loop 70, which can include regulator 62 and thermos valve 64. Regulator 62 can comprise any suitable device as is known in the art that allows excess capacity of water pump 16 to be drawn off of the output of water pump 16 without affecting the pressure generated by water pump 16. As such, water pump 16 can continuously run regardless of whether water is being dispensed by wand 114. Regulator 62 can receive high pressure water from water pump 16 at line 72A and return high pressure water to the water box of heat exchanger 20 at line 72B. As such, water pump 16 can continue to pressurize and pump water no matter how much water is being drawn at wand 114. Furthermore, regulator 62 can be connected to thermo valve 64 via line 72C. Thermo valve 64 can be configured to open if water in regulator loop 70 reaches a threshold temperature level. For example, even if wand 114 is operating to dispense water, a certain amount of water can continue to re-circulate in regulator loop 70, thereby rising in temperature due to, among other things, the mechanical compression process. Thus, thermo valve 64 can open to dump hot water trapped in regulator loop 70 to recovery tank 111. This subsequently can cause new, cold water to be admitted into the water box of heat exchanger 20, which can include a level sensor and/or a level valve to admit water based on the level of water in the water box of heat exchanger 20.

Water from water pump 16 can continue to second heat exchanger 22 via line 34C where it is, in the example of FIG. 4, first heated be coolant from power plant 104B. The heated water continues into third heat exchanger 24 via line 34D after passing through 3-way valve 66. 3-way valve 66 can comprise an actively controlled valve that is opened based on temperatures sensed by temperature sensor 28. For example, output from sensor 28 can be provided to temperature control 68, which can then compare the sensed temperature to temperature input 74 set by an operator of system 60. When the temperature sensed by sensor 28 exceeds the operator-specified level, temperature control 68 can send a signal to 3-way valve 66 that causes valve 66 to open and route water around third heat exchanger 24 through bypass line 76 to line 34E, where it flows into resistance heater 26.

When water is not flowing through bypass line 76, third heat exchanger 24 operates to heat the water using heated exhaust gas from vacuum pump 18. Temperature control 68 coordinates operation of resistance heater 26 and 3-way valve 66 in conjunction with operation of second heat exchanger 22 to maintain water at the level specified by the operator, such as at temperature input 74.

In both the examples of FIG. 1 and FIG. 4, water can be heated for the cleaning process in three zones in order to effectively utilize each available heat source. The first zone can use heat from power plant 104B. The second zone can use heat from vacuum pump 18. The third zone can use heat from resistance heater 26.

The first zone can use heat from the combustion process within power plant 104B that is transferred to a coolant of the cooling system of power plant 104B. The coolant can be put into thermal communication with the water through the use of various liquid-to-liquid heat exchangers, such as first heat exchanger 20 or second heat exchanger 22. This is the highest volume heat source, but the lowest grade heat source available. The highest percentage of heat load comes from this source. This zone is not actively controlled, except by the thermostat in the vehicle engine.

The second zone can use heat from compressed air exhausted from vacuum pump 18. The compressed air is elevated in temperature during the compression process. The air can be put into thermal communication with the water through the use of various air-to-liquid heat exchangers, such as third heat exchanger 24. This zone can be actively controlled by the use of a recirculation loop comprising bypass line 76 that bypasses third heat exchanger 24 using 3-way valve 66 and temperature sensor 28. The second zone can also be passively controlled using a mechanical temperature limit device and heat bank. A recirculation loop can be formed between the third heat exchanger and the heat bank such that hot exhaust air can be put into heat transfer with the recirculation loop, rather than directly with the water. In other words, the hot air can transfer heat to the heat bank, the heat bank can transfer heat to the recirculation loop, and the recirculation loop can transfer heat to the water. The temperature of the heat bank can be controlled using the mechanical temperature limit device to prevent the heat bank from exceeding a predetermined temperature level. As such, the amount of heat from the hot exhaust gas imparted into the water can be passively limited by mechanical means.

The third heating zone is comprised of resistance heater 26 and is used to precisely control the temperature of the water at wand 114 as the water engages the heating surface. A hose forming line 34F and 34G can be embedded with one or more resistance heating elements that allow the water being flowed inside the hose to be heated on its way to wand 114 and the cleaning surface. In another example, one or more resistance heating elements can be mounted within the housing of the carpet cleaning machine at wand 114. At wand 114, temperature sensor 28 reads the water temperature and transmits that reading back to temperature control 68. In one example, temperature sensor 28 can include a radio transmitter that can communicate with temperature control 68. In another example, temperature sensor 28 can be connected to temperature control via wiring. In an example, temperature sensor 28 can be located at the end of line 34G attached to wand 114.

FIG. 5 is a schematic illustration of electrical system 40 of FIG. 3 configured to have A/C voltage output 80. Electrical system 40 can include generator 12, battery 107, generator control 42, first contactor 46A, and second contactor 46B, as discussed above. However, rather than being configured to generate three-phase AC electrical power to drive an electric motor, electrical system 40 can be configured to provide DC output at DC voltage bus 82 using inverter 84 and engine speed control 86. As such, electric system 40 can be installed within truck 100 or any other vehicle having a power plant, such as an internal combustion engine, to generate DC output for powering auxiliary systems of the vehicle or installed in the vehicle. For example, electrical system 40 can be used to provide power to communications technology, such as for use in television and radio broadcast news vehicles, or police, fire and military command centers.

Power plant 104A can operate to provide rotational input to electric generator 12, such as by use of belt 88. However, other suitable power transfer devices may be used. In one example, power plant 104 comprises a typical internal combustion engine as is found in a light duty vehicle. In one example, electric generator 12 can comprise a permanent magnet synchronous generator. Three-phase AC power generated by generator 12 can be transmitted to generator control 42 via power lines 53A-53C, with contactors 46A and 46B being provided to inhibit power transmission therebetween, as discussed above. Generator control 42 can produce DC power that can be provided via terminals 54A and 54B to inverter 84, which produces DC voltage at DC voltage bus 82. Inverter 84 may comprise any suitable DC/AC inverter as is known in the art, such as a sine wave inverter.

Battery 107 can provide power to generator control 42 via terminals 57A and 57B. Generator control 42 can also be in electronic communication with engine speed control 86. Power plant 104B can be controlled by engine speed control 86 and can provide direct mechanical power to electric generator 12. The speed of power plant 104B can be regulated by generator control 42 based on load induced on DC voltage bus 82. Varying the speed of power plant 104B based on load can result in reduced overall fuel consumption and wear on power plant 104B.

AC voltage is produced by taking the DC bus voltage output from generator control 42 and running that voltage output through a sine wave inverter to produce AC output. Since generator control 42 regulates the DC power bus independent of the AC voltage and frequency produced by generator 12, the speed of generator 12 is not a limiting factor as is the case in some other conventional AC generators. This allows the speed of power plant 104B to vary, while electric system 40 still outputs a steady AC voltage output from inverter 84.

As discussed herein, electrical system 40 can be advantageously used in vehicle installed cleaning systems to reduce wear on the vehicle, improve control over the cleaning system air pressure, air volume and water temperature, and improve the user convenience of operating the system.

### Various Notes

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

1-28. (canceled)

29. A vehicle power system for providing input to an auxiliary system, comprising:
a vehicle-mounted power plant having a fluid cooling system;
a generator mechanically coupled to the power plant; and
a motor electrically coupled to the generator to provide mechanical input to an auxiliary system;
wherein the fluid cooling system is configured to cool the generator and motor.

30. The vehicle power system of claim 29, further comprising first cooling lines connecting the fluid cooling system of the power plant and the generator to circulate coolant therebetween.

31. The vehicle power system of claim 30, further comprising:
a pump coupled to the motor and configured for generating pressurized liquid;
a blower coupled to the motor and configured for generating pressurized air; and
a cleaning tool fluidly coupled to a pump outlet and a blower inlet;
wherein the fluid cooling system is configured to heat liquid for the cleaning tool.

32. The vehicle power system of claim 31, further comprising:
second cooling lines connecting the fluid cooling system of the power plant and the motor in order to circulate fluid therebetween; and
a liquid-to-liquid heat exchanger in fluid communication with the second cooling lines and an inlet configured to receive liquid from the pump and an outlet for providing heated liquid to the cleaning tool.

33. The vehicle power system of claim 32, further comprising:
a preheater liquid-to-liquid heat exchanger configured to heat liquid stored in a container using heated coolant from the fluid cooling system.

34. The vehicle power system of claim 32, further comprising a resistance heater positioned to heat liquid between the liquid-to-liquid heat exchanger and the cleaning tool.

35. The vehicle power system of claim 34, wherein the resistance heater is disposed in a hose connecting the cleaning tool to the liquid-to-liquid heat exchanger.

36. The vehicle power system of claim 34, further comprising a liquid-to-air heat exchanger positioned between the resistance heater and the liquid-to-liquid heat exchanger and configured to exchange heat between discharge air of the blower and the heated liquid.

37. The vehicle power system of claim 36, further comprising:
a temperature sensor positioned between the resistance heater and the cleaning tool; and
a bypass valve connected to allow liquid to bypass the liquid-to-air heat exchanger when the temperature sensor senses a threshold temperature.

38. The vehicle power system of claim 31, further comprising:
a generator control connected to the generator to convert alternating current to direct current; and
a motor control connected to the generator control and the motor to convert direct current to alternating current.

39. The vehicle power system of claim 38, further comprising:
a pressure control connected to the motor control and configured to adjust a voltage signal sent to the motor by the motor controller to limit a maximum air pressure at the cleaning tool; and
a flow control connected to the motor control and configured to adjust a voltage signal sent to the motor by the motor control to limit a minimum airflow through the cleaning tool.

40. The vehicle power system of claim 39, further comprising a vacuum sensor connected to the motor control and configured to sense a pressure of a vacuum tank connected to the blower.

41. A method of operating an auxiliary power system for a vehicle, the method comprising:
driving an electric generator with a power plant of a vehicle;
powering an electric motor with power from the electric generator; and
cooling the electric generator and the electric motor with cooling fluid of the power plant;

42. The method of claim 41, further comprising:
heating a cleaning fluid with heat from the cooling fluid; and
driving a fluid pump with the electric motor to pump cleaning fluid to a cleaning tool.

43. The method of claim 42, further comprising heating the cleaning fluid with heat from the cooling fluid at the fluid pump inlet and the fluid pump outlet using liquid-to-liquid heat exchangers.

44. The method of claim 42, further comprising heating the cleaning fluid between the cooling fluid and the cleaning tool with an electric heater.

45. The method of claim 42, further comprising driving a blower with the electric motor to draw cleaning fluid away from a discharge of the cleaning tool.

46. The method of claim 45, further comprising heating the cleaning fluid in route to the cleaning tool with discharge air from the blower using a liquid-to-air heat exchanger.

47. The method of claim 46, further comprising:
sensing a temperature of the cleaning fluid at the cleaning tool; and
bypassing the liquid-to-air heat exchanger when a sensed temperature exceeds a threshold temperature.

48. The method of claim 45, further comprising:
controlling output of the electric generator with a generator control that converts alternating current to direct current; and
controlling input to the electric motor with a motor control that converts direct current to alternating current.

49. The method of claim 48, further comprising
adjusting a voltage signal sent to the electric motor by the motor control to limit a maximum air pressure at the cleaning tool; and
adjusting a voltage signal sent to the electric motor by the motor control to limit a minimum airflow through the cleaning tool.

50. The method of claim 49, further comprising sensing pressure in a vacuum tank connected to the blower.

51. An electrical generator system for a vehicle, the electrical generator system comprising:
a power plant having a fluid cooling system;
an alternating current generator mechanically coupled to the power plant;
a generator control coupled to receive electrical input from the alternating current generator; and
an engine speed control configured to receive a control signal from the generator control and to provide an input to the power plant to control speed of the power plant;
wherein the fluid cooling system is configured to cool the alternating current generator.

52. The electrical generator system of claim 51, wherein:
the power plant comprises an internal combustion engine that generates rotational shaft power; and
the fluid cooling system includes a heat exchanger configured to exchange heat from coolant heated by the power plant to the atmosphere.

53. The electrical generator system of claim 51, further comprising:
a plurality of electrical contactors configured to interrupt reception of electrical input from the alternating current generator by the generator control; and
a battery connected to the generator control.

54. The electrical generator system of claim 51, further comprising an inverter connected to the generator control to generate direct current power.

55. The electrical generator system of claim 54, further comprising a motor electrically powered b the alternating current generator.

56. The electrical generator system of claim 55, further comprising:
a liquid pump mechanically powered by the motor; and
an air blower mechanically powered by the motor.

57. The electrical generator system of claim 56, wherein the fluid cooling system is used to cool the generator and the motor, and heat liquid pumped by the liquid pump.

58. The electrical generator system of claim 57, wherein heated liquid is used in conjunction with a carpet cleaning tool that utilizes a vacuum generated by the air blower.
